(19) United States
(12) Patent Application Publication
(10) Pub. No.: US 2007/0160949 A1
(43) Pub. Date: Jul. 12, 2007

(54) Orthodontic bracket

(76) Inventor: John C. Voudouris, Toronto (CA)

Correspondence Address: MICHAEL BEST & FRIEDRICH, LLP, 100 E WISCONSIN AVENUE, Suite 3300, MILWAUKEE, WI, 53202, US

(21) Appl. No.: 10/592,184

(22) PCT Filed: Mar. 8, 2005
(86) PCT No.: PCT/CA05/00366

§ 371 Date: Sep. 8, 2006

Related U.S. Application Data
(60) Provisional application No. 60/551,281, filed on Mar. 8, 2004.

(51) Int. Cl. A61C 3/00

(52) U.S. Cl. 433/8

(57) ABSTRACT

An orthodontic bracket comprising a body having an archwire slot and adapted to be secured to a tooth, and a clip coupled to the body and movable between an open position, permitting access to the archwire slot, and a closed position, inhibiting access to the archwire slot. The clip comprises a base material and a coating coupled to at least a portion of the base material. The can be made of a ceramic material (e.g., polycrystalline alumina). A surface of the clip is preferably treated to enhance adhesion of the coating.

### FIELD OF THE INVENTION

The present invention relates to orthodontic brackets and, more particularly, to orthodontic brackets that are designed to have a surface color that blends into the patient's teeth so that the bracket is less noticeable.

### BACKGROUND OF THE INVENTION

According to established orthodontic techniques, it is well known to attach an orthodontic bracket to a patient's tooth. The bracket provides a location for attaching an archwire and other orthodontic devices to facilitate movement of the tooth. According to established orthodontic techniques, it is well known to ligate an archwire to the orthodontic bracket utilizing an elastic or metal ligature. In conventional orthodontic brackets, the ligature is wrapped around respective gingival and occlusal tie wings so as to overlay the archwire at mesial and distal ends of the orthodontic bracket.

Typically, orthodontic brackets are made of a metallic material, such as stainless steel. These materials are commonly used because they are strong, non-staining, and relatively inexpensive. However, metallic materials can be cosmetically undesirable because they do not match the color of the patient's teeth, and thus the resulting brackets are very noticeable. To overcome the cosmetic difficulties noted above, manufacturers have developed brackets made from ceramic materials, such as polycrystalline alumina. These materials can be developed to closely match the color of the patient's teeth, thus resulting in a bracket that is less noticeable than common metal brackets.

Recently, designers have created self-ligating brackets that do not require a separate ligature for attachment of the archwire to the bracket. One type of self-ligating bracket is supplied with a clip that is movable between an open position, permitting access to the archwire slot, and a closed position, inhibiting access to the archwire slot. Self-ligating brackets substantially decrease the time involved in performing ligation procedures.

### SUMMARY OF THE INVENTION

The present invention provides a self-ligating orthodontic bracket that is designed to have an exterior color that can be selected by the doctor or patient and can be different than the typical metallic color. In one aspect, the bracket of the present invention comprises a body having a lingual surface for attachment to a tooth and defining an archwire slot. The bracket further includes a clip movable between an open position, permitting access to the archwire slot, and a closed position, inhibiting access to the archwire slot. The clip comprises a base material and a coating that is designed to change the aesthetic characteristics of the base material. The base material can be made of any of a number of different materials, such as chromium-cobalt, nickel-titanium, or stainless steel. The coating can be any of a number of different materials, such as composite resin hydroxyappatite, porcelain, epoxy, and lead free enamel paint. The coating can be applied to the base material by any of a number of different processes, including physical vapor deposition, chemical vapor deposition, painting, dipping, or spraying.

In one embodiment, the base material of the clip provides a treated (e.g., roughened) surface to enhance the attachment of the coating to the surface of the base material. For example, the surface of the base material can be laser etched, chemically etched, or mechanically etched. In one embodiment, the surface of the base material is etched to form undercuts that provide mechanical engagement of the coating to the surface of the base material. In another embodiment, the surface of the base material is provided by a mesh layer that is secured to the surface of the base material. For example, the mesh layer can be a metal mesh that is brazed to the surface of the base material. In yet another embodiment, the surface of the clip can be bombarded with particles to create microcraters. In still another embodiment, the surface of the clip can be coated with micro-sintered balls.

In a different embodiment of the present invention, the clip can be made using a polymeric material, such as polycarbonate, polyethylene, amplified polypropylene resin, and polyvinyl chloride. Preferably, the polymeric material is either clear or colored to match the tooth. For added strength, the clip can also include a reinforcing fiber (e.g., fiberglass or steel).

Other features and aspects of the invention will become apparent to those skilled in the art upon review of the following detailed description, claims, and drawings, wherein like elements have like numerals throughout the drawings.

### BRIEF DESCRIPTION OF THE DRAWINGS

FIG. 1 is a perspective view of an orthodontic bracket embodying the present invention.

FIG. 2 is a perspective view of a second orthodontic bracket embodying the present invention.

FIG. 3 is a perspective view of a third orthodontic bracket embodying the present invention.

FIG. 4 is a partial perspective view of a clip that has been laser etched.

FIG. 5 is an enlarged detail of the clip of FIG. 4.

FIG. 6 is an enlarged detail of an alternative etching configuration.

FIG. 7 is a perspective view of a clip having a mesh layer attached to its surface.

FIG. 8 is an enlarged detail of the clip of FIG. 7.

FIG. 9a and 9b illustrate a clip that has been bombarded with particles to produce a surface having microcraters, and FIG. 9c illustrates the clip with a coating.

FIGS. 10a, 10b, and 10c illustrate a clip having micro-sintered balls on its surface.

FIG. 11 illustrates a clip having micro-sintered balls that have been bombarded to produce microcraters.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including,” “having,” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

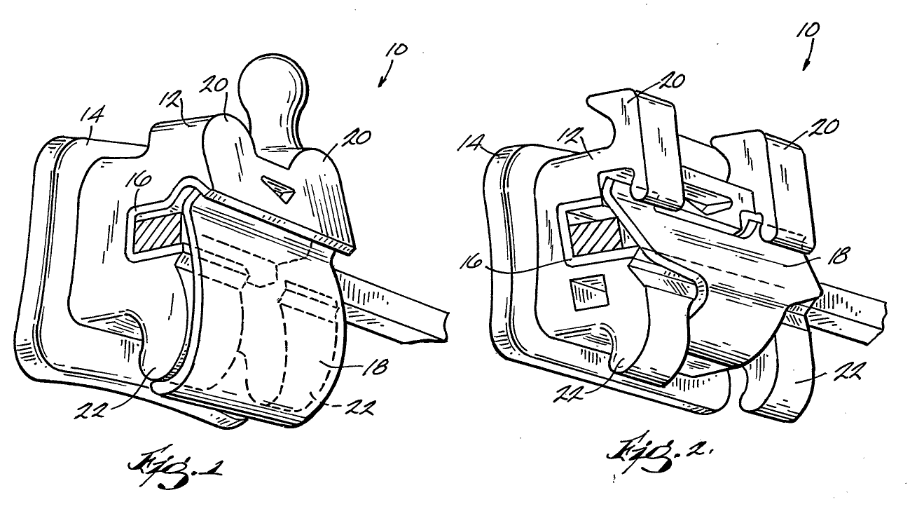

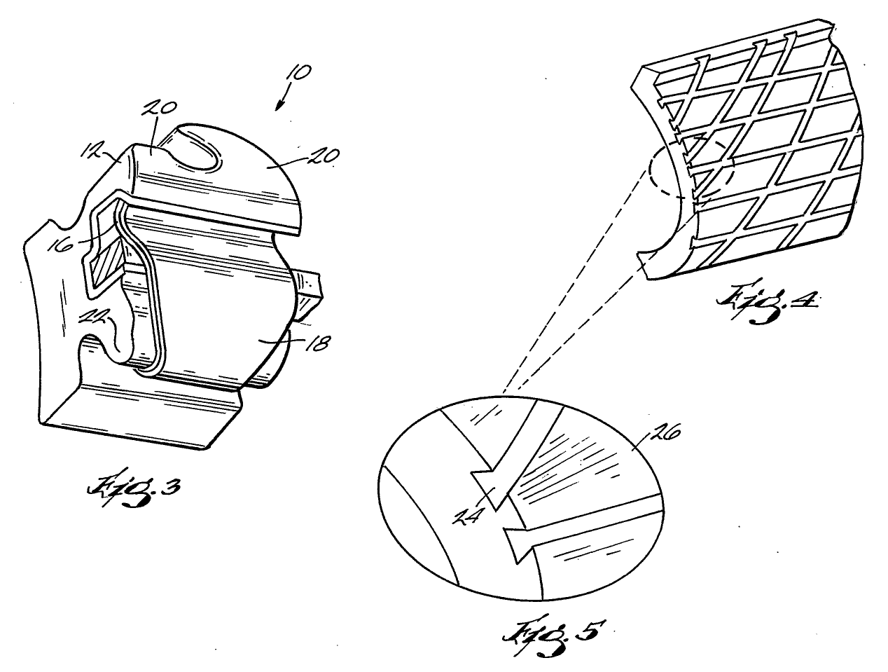

FIGS. 1-3 illustrate self-ligating orthodontic brackets 10 having a body 12, a mounting pad 14, a lateral insert 16, and a clip 18. Only the bracket of FIG. 1 will be described below, but a substantial portion of the following description generally applies to any of the brackets.

The mounting pad 14 includes a lingual surface 15 adapted to be connected to a labial surface of a tooth (not shown). The body 12 includes a lingual surface that is connected to a labial surface of the mounting pad 14. The body 12 defines gingival and occlusal directions and mesial and distal directions, as in known in the art. The body 12 includes two gingival tie wings 20 extending from the body 12 in the gingival direction and two occlusal tie wings 22 extending from the body 12 in the occlusal direction. The body 12 and the mounting pad 14 of the illustrated bracket 10 are made from a ceramic material (e.g., polycrystalline alumina) and are integrally formed with each other. Alternatively, the body 10 and mounting pad 12 can be separate from each other while remaining within the scope of the present invention. The separate body 12 and mounting pad 14 can be connected by an adhesive, resin, weld, or other connecting method known by those of ordinary skill in the art. In addition, the body 12 and the mounting pad 14 could be made from other materials such as ceramic, polymers, resins, metals, or the like.

The illustrated clip 18 is made from a chromium-cobalt base material and a porcelain coating. The base material is designed to provide the flexibility required for the clip to move between the open and closed positions, and to provide the strength to engage the archwire and provide movement to the tooth. The surface is oxidized during the heating process required for porcelain to enhance adhesion of the coating. As an alternative to chromium-cobalt, it is anticipated that other materials could be used, such as nickel-titanium, or stainless steel.

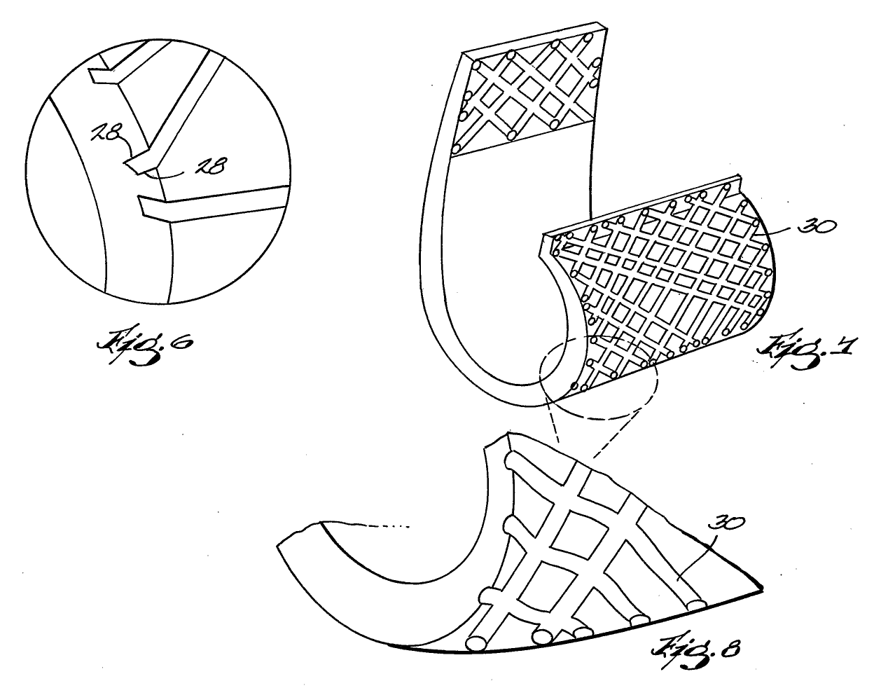

To enhance to attachment of the coating, the base material is roughened. Referring to FIGS. 4-5, the base material is laser etched to form undercuts 24 in the surface 26 of the base material. The undercuts provide an increased surface area and a mechanical engagement between the base material and the coating (not shown in FIGS. 4-5). FIG. 6 illustrates an alternative etching configuration having parallel walls 28 on the sides of the groove formed by the etching procedure. Instead of laser etching, chemical or mechanical etching, or a combination of the above could be used.

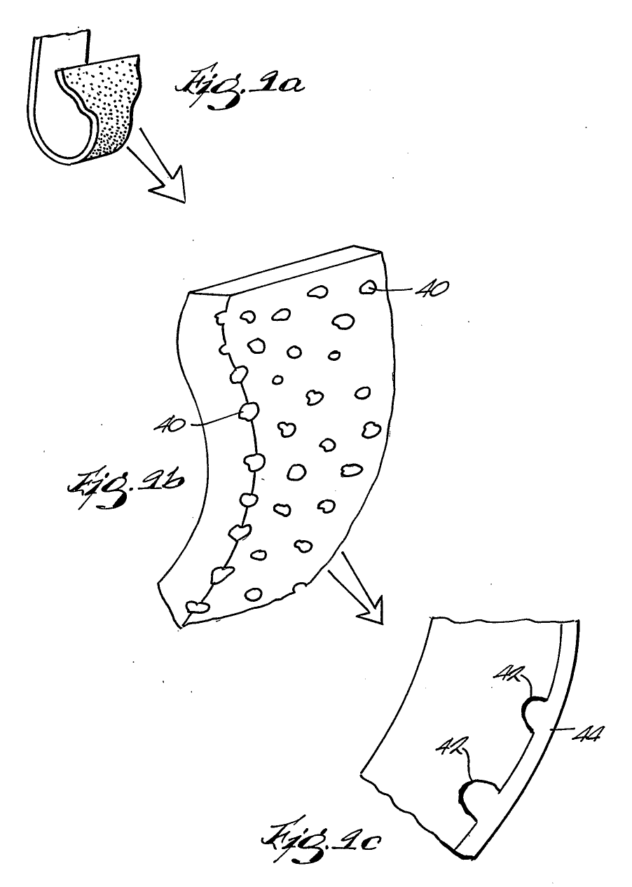

As an alternative to etching, the surface of the base material could be provided with a mesh layer 30. The mesh layer illustrated in FIGS. 7-8 comprises a metal mesh that is brazed to the surface of the base material. The mesh layer is provided on exposed surfaces of the clip 18, such as the labial surfaces of an engaging portion 32 and a guide portion 34 of the clip 18. In this embodiment, it is believed that a composite resin coating or an epoxy coating (not shown in FIGS. 7-8) will provide good results.

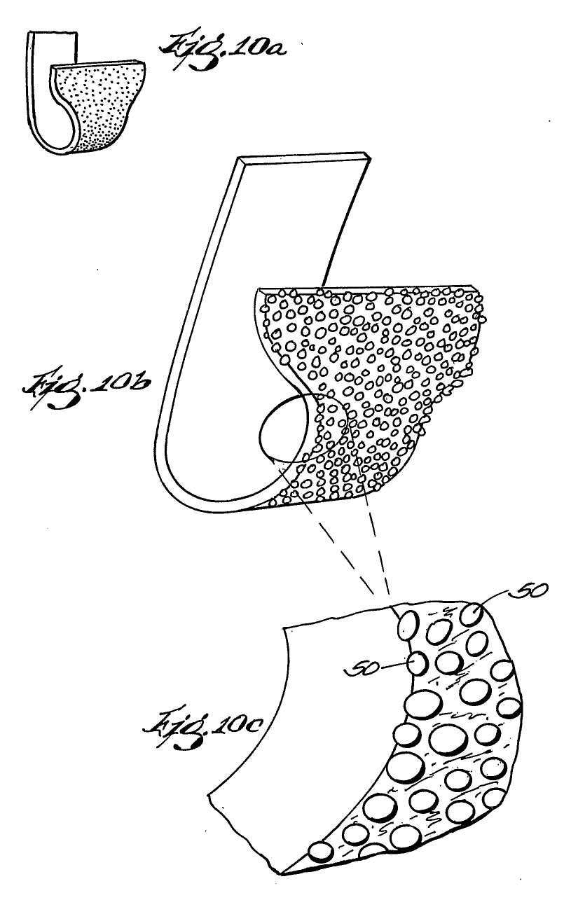

In one embodiment, aluminum oxide bombardment is used to create micro-craters 40 in the clip surface, as shown in FIGS. 9a-9c. A second bombardment with coated particles leaves the micro-craters with a silicon dioxide coating 42. The surface of the clip is then primed with a silane coating followed by a resin bonding 44 (e.g., BisGMA methylmethacsylote), as shown in FIG. 9c, which can be colored to provide the desired aesthetic result. The resin bonding 44 is more flexible, for example, than porcelain coating, and thus is more tolerant of metal flexing.

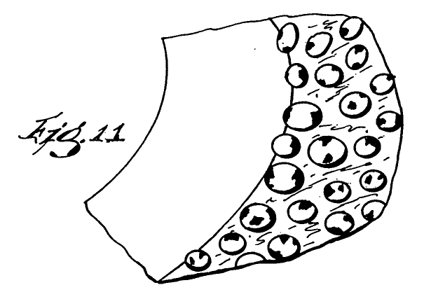

Another process for pretreating the surface of the clip involves the use of protrusive micro-sintered balls 50 that are secured to the surface of the metal clip, as shown in FIGS. 10a-10c. The micro-sintered balls create a textured surface having a greatly magnified surface area (as much as 200% greater). Cosmetic coating (e.g., a resin bonding) can then be applied over the sintered surface, where it will be firmly held in place. For enhanced adhesion, the surface having micro-sintered balls 50 can be bombarded with aluminum oxide particles and silicon dioxide particles (see FIG. 11), and then primed with a silane coating followed by resin bonding, as described above in connection with FIGS. 9a-9c.

The coating is designed to provide the ability to create a self-ligating bracket having colors, such as the color of a tooth. The coating can also provide corrosion resistance and a smoother feel to the patient. In the embodiment of FIG. 1, the porcelain coating is applied to the base material when the base material is hot. The coating can be applied by PVD, CVD, painting, spraying, dipping, or other suitable process depending on the material.

Instead of porcelain, it is believed that the coating could include hydroxyappatite, epoxy, or enamel paint. It is preferred that these materials would be substantially free of lead. The enamel paint or epoxy could be applied by electrostatic spraying, and a varnish sealant can then be applied.

Instead of the above-described coated clip, the clip could instead be made of a polymer material, such as a clear high-density polyurethane. This clip provides the required aesthetics by allowing the body to be viewed through the clip. The clip will benefit from the addition of strengthening fibers, such as fiberglass, carbon fiber, or Kevlar. In addition, the clip could be colored to almost any desired color. Instead of polyurethane, the clip could comprise polycarbonate, poly (ethylene-co-terepthalate resin), amplified polypropylene resin, and polyvinyl chloride. Any of these alternative materials could benefit by the addition of fiber reinforcement.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention.

We claim:

1. An orthodontic bracket comprising:
a body having an archwire slot and adapted to be secured to a tooth, and
a clip coupled to the body and movable between an open position, permitting access to the archwire slot, and a closed position, inhibiting access to the archwire slot, wherein the clip comprises a base material and a coating coupled to at least a portion of the base material.

2. The orthodontic bracket of claim 1, wherein the body comprises a ceramic material.

3. The orthodontic bracket of claim 2, wherein the ceramic material comprises polycrystalline alumina.

4. The orthodontic bracket of claim 1, wherein the base material comprises a metallic material having a surface that is treated to enhance adhesion of the coating.

5. The orthodontic bracket of claim 4, wherein the surface is etched.

6. The orthodontic bracket of claim 4, wherein the surface includes undercuts.

7. The orthodontic bracket of claim 4, wherein the surface includes a mesh layer.

8. The orthodontic bracket of claim 4, wherein the surface includes microcraters.

9. The orthodontic bracket of claim 8, wherein the microcraters include a silicon dioxide coating.

10. The orthodontic bracket of claim 4, wherein the surface includes microspheres.

11. The orthodontic bracket of claim 1, wherein the coating is colored to approximate the color of the tooth.

12. The orthodontic bracket of claim 1, wherein the coating comprises a material selected from the group consisting of porcelain, epoxy, enamel, and hydroxyappatite.

13. A method of making a clip for a self-ligating orthodontic bracket, comprising:
creating a clip from a base material;
treating a surface of the base material; and
applying a coating to at least a portion of the surface.

14. The method of claim 13, wherein treating includes etching a surface of the clip.

15. The method of claim 13, wherein treating includes forming undercuts into the surface of the clip.

16. The method of claim 13, wherein treating includes forming a mesh layer onto the surface of the clip.

17. The method of claim 13, wherein treating includes forming microcraters into the surface of the clip.

18. The method of claim 17, wherein forming includes adding a silicon dioxide layer.

19. The method of claim 13, wherein applying includes utilizing a coating having a color to approximate the color of a tooth.

20. The method of claim 13, wherein the coating comprises a material selected from the group consisting of porcelain, epoxy, enamel, and hydroxyappatite.
